(19) United States
(12) Patent Application Publication
(10) Pub. No.: US 2017/0099149 A1
(43) Pub. Date: Apr. 6, 2017

(54) System and Method for Securing, Tracking, and Distributing Digital Media Files

(71) Applicant: SoniMark, LLC, Lewisville, TX (US)

(72) Inventors: Michael Eber, Flower Mound, TX (US); Harold E. Fitzgerald, Lewisville, TX (US)

(73) Assignee: SONIMARK, LLC, Lewisville, TX (US)

(21) Appl. No.: 14/874,207

(22) Filed: Oct. 2, 2015

(51) Int. Cl. H04L 9/32; G06F 21/16; H04L 29/08

(52) U.S. Cl. CPC H04L 9/3247; H04L 67/06; H04L 67/10; G06F 21/16

(57) ABSTRACT

A system and method are described for sharing, playing, storing, and managing audio files. Audio files can be stored in the cloud and shared among a limited group of users, wherein an uploading user can set permissions for the uploaded file. When an audio file is shared with other users the audio file is watermarked, transcoded and encrypted so that it is only playable within the disclosed system. Playing and location data is tracked regarding user devices so that if a file is leaked or stolen, the watermark will allow the system to determine what device is the source of the leak or theft.

### TECHNICAL FIELD

The present disclosure is directed to the distribution of digital files, and more particularly to a system and method for securing, tracking, and distributing digital files.

### BACKGROUND OF THE INVENTION

Piracy is a problem for producers of various types of digital files, such as music and movies. Producers of such content deserve to be paid fairly for their work. But if a digital file, such as a song, is stolen then it can be copied and distributed widely and quickly. The content maker or owner can then be deprived of the expected income for their work. Artists may also want to only distribute finished versions of their work and not let unfinished mixes reach the public.

One piracy problem occurs once a piece of work has been released to the public. When an album is released, for example, it will in all likelihood be digitally copied by many people and distributed unlawfully for free. Another distinct, but related, problem is the piracy of unreleased works. For example, a music artist may spend many months working on a new album. Various songs, and versions of songs, may be sent back and forth between band members, producers, record label representatives and other people. During this process it is not uncommon for a leak to occur—and a musician's song ends up available to the public against the musician's wishes. Unfortunately, it will often prove difficult to determine who leaked the song. Oftentimes, various people had access to the leaked song. Furthermore, the song may have been stolen by a hacker. In such cases, nobody who received the song from the musician would be guilty of the leak, but it may be tough to determine which recipient's security is inadequate and needs to be changed.

### BRIEF SUMMARY OF THE INVENTION

One embodiment of the present teachings comprises a method of watermarking an audio file comprising: receiving, at a server, a digital audio file; receiving, at a server, a request for the digital audio file, the request comprising a user device identification and a file format request; deriving, at a server, a first hash, the first hash comprising a unique user device identification value; deriving, at a server, a second hash, the second hash comprising an instance unique identification value; embedding, at a server, at least a portion of the first hash at locations within the digital audio file determined by the second hash to create a watermarked file; transcoding, at a server, the watermarked file into the file format requested; encrypting, at a server, the watermarked file and transcoded file; and sending, by a server, the encrypted file to the user device.

Another embodiment comprises a method of creating and sharing audio files comprising: receiving, at a server, a digital audio file from a first user; encrypting, at a server, the digital audio file; receiving, at a server, permission settings for the digital audio file from the first user; receiving, at a server, a request for the digital audio file from a second user, the request comprising a user device identification; determining, at a server, that the permission settings allow the second user to download the digital audio file; deriving, at a server, a first hash, the first hash comprising a unique user device identification value; deriving, at a server, a second hash, the second hash comprising an instance unique identification value; embedding, at a server, at least a portion of the first hash at locations within the digital audio file determined by the second hash to create a watermarked file; transcoding, at a server, the watermarked file into the file format requested; encrypting, at a server, the watermarked file and transcoded file; and sending, by a server, the encrypted file to the user device of the second user.

Another embodiment comprises a system for watermarking, encrypting, and storing audio files comprising: a secure proxy located outside a firewall and operable to communicate with a plurality of front end devices; a cloud storage located inside the firewall and in communication with the secure proxy, and operable to store encrypted audio files; a statistics database located inside the firewall and in communication with the secure proxy, and operable to receive location and play data regarding audio files from the plurality of front end devices; a request server located inside the firewall and in communication with the secure proxy, the cloud storage and the statistics database, and operable to receive unencrypted audio files from the plurality of front end devices, further operable to receive a download request for an audio file from a requesting front end device; a watermark server located inside the firewall and in communication with the request server, and operable to receive a requested audio file from the request server and embed a first and second hash within the requested audio file, wherein the first hash is unique to a front end device and the second hash is instance unique, and wherein at least a portion of the first hash is embedded in the requested audio file in at least one location determined by at least a portion of the second hash; a transcoder located inside the firewall and in communication with the request server, and operable to receive the watermarked requested audio file from the request server and to transcode the watermarked requested audio file into a desired audio format; an encryption server located inside the firewall and in communication with the request server, and operable to received the transcoded requested audio file from the request server and to encrypt the transcoded requested audio file; a file index located inside the firewall and in communication with the request server and operable to store encryption keys; an account server located inside the firewall and in communication with the request server and operable to store permission settings related to an audio file; and wherein, when the request server receives a download request from a requesting user the request server confirms the requesting user's permissions with the account server, the request server then copies the requested audio file from the cloud storage and sends it to the watermark server to be watermarked, then to the transcoder to be transcoded, and then to the encryption server to be encrypted, and then sends the encrypted, transcoded and watermarked audio file to the requesting user.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a diagram of an embodiment of the present teachings.

FIG. 2 is a diagram of a system embodiment of the present teachings.

FIG. 3 is a diagram of a player/application embodiment according to the present teachings.

FIG. 4A is a diagram of a user interface embodiment according to the present teachings.

FIG. 4B is a diagram of a user interface embodiment according to the present teachings.

FIG. 5 is a flow-chart diagram of a process embodiment according to the present teachings.

FIG. 6 is a flow-chart diagram of a process embodiment according to the present teachings.

FIG. 7 is a flow-chart diagram of a process embodiment according to the present teachings.

### DETAILED DESCRIPTION OF THE INVENTION

The present disclosure contains numerous embodiments of a sonic watermarking system and method that allows greater control and security over digital files, such as music. One embodiment comprises the use of two hash functions that are used to create a sonic watermark on an audio file. The present disclosure also includes a file sharing system. For example, a musician may wish to share a song with four other people. Each of the five people involved (musician and four recipients) will need to use the system described herein. The musician can upload his song and send notifications to the four recipients that they can access the song. Each of the recipients (using the system described herein) can download the song from server(s). Each recipient will receive a digital file with a sonic watermark created using two hash functions as described above. The first hash function is user device specific (unique to each of the recipients' downloading device) and will determine a plurality of locations within the digital file of the song. The second hash is “instance” specific. An “instance” of a file is a single download of a given file. The second hash will be embedded at locations determined by the first hash. If a song is leaked to the public, the first and second hashes provide a sonic watermark that can trace the leaked song to the leaking source.

The meaning of “instance”, for the purposes of this specification, will become clear as embodiments are described. The word “instance” is used to help distinguish from “version.” Version will describe the various iterations of a song as it is developed over time by a musician. For example, a musician may explore adding or subtracting various instruments or harmonies over the course of creating a song. A first version may have drums but a second and third version may not. A fourth version may incorporate drums again as the musician decides he wants the drums. In contrast, “instance” refers to an individual download of a specific digital file. For example, a musician may send version four of a song to twenty people. Each of the twenty copies created for the twenty recipients will be a unique instance. In another example, a musician may send a song to a user with four different devices. If the sender allows the recipient to download the song to all four devices then each device will have a unique instance (in addition to having unique devices).

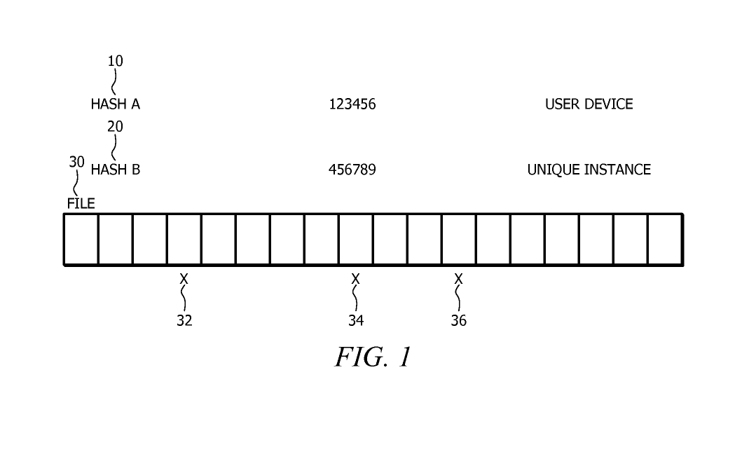

Referring to FIG. 1, an embodiment of the first and second hashes are shown with a representative digital file. First hash 10 (Hash A) and second hash 20 (Hash B) each have an output of six digits. This is for illustrative purposes only, as hash functions typically have a longer output, such as 128 or 256 digits. A hash function is a mathematical function used to map an input of variable size to an output of fixed size. Sample hash functions useable with the current disclosure are the SHA (secure hash algorithm) hash functions published by the National Institute of Standards and Technology, though others could be used. The preferred embodiment uses two different hash functions. As shown in FIG. 1, the first hash 10 will be used to select several locations 32, 34, 36 within digital file 30. For example, the first hash 10 in this example is 123456. Locations 32, 34, 36 could be determined by using the 12th byte, 34th byte, and 56th byte of digital file 30. Or alternatively, the locations could be the 123rd byte, and the 456th byte. A user has a variety of methods to use first hash 10 to determine the locations 32, 34, 36 (which can comprise any plurality of locations). Values from second hash 20 will be embedded or inserted into digital file 30 at locations 32, 34, 36. In this example, the entire second hash 456789 could be inserted at each location 32, 34, 36. In other embodiments, various portions of second hash 20 can be inserted at 32, 34, 36. For example, ‘45’ could be assigned to location 32, ‘67’ could be assigned to location 34, and ‘89’ could be assigned to location 36. Various ways of embedding second hash 20 into digital file 30 at the plurality of locations 32, 34, 36 are feasible according to the teachings disclosed herein. In one embodiment, a byte is read from the hash. For each bit in the hash, a byte is read from the key. Based on the byte, a number x samples are skipped. One sample is read from the wave stream, the last bit of the sample is changed, the result is written to the destination wave stream.

The sonic watermark created by first and second hashes 10 and 20 will be inaudible to a human listener, but will still be present in any audio recording of a watermarked file. For example, a band member may play excerpts from an upcoming album from this computer for a friend. If the friend surreptitiously records the song with a recording device, and later attempts to distribute the song, the watermark will still be present. The leak can be traced back to the band member. The band member may not be liable for any wrong doing, but he would be able to narrow the list of suspects of who secretly recorded the song, and can probably determine who the guilty party is. Watermark service 141 can use a variety of systems or methods to apply the watermark to the digital file. Example watermarking techniques include: below or above voice band signal modulation, narrow band frequency notch technique, multiple narrow band frequency notch technique, spread spectrum, ancillary data stream and others. Combinations of the above can be used as well. Generally, the watermark must be inaudible, survivable (surviving compression or other algorithms), invisible (undetectable by typical audio analysis methods), and indelible (unable to be removed without damaging the audio file). Any such method known in the art can be compatible with the present teachings.

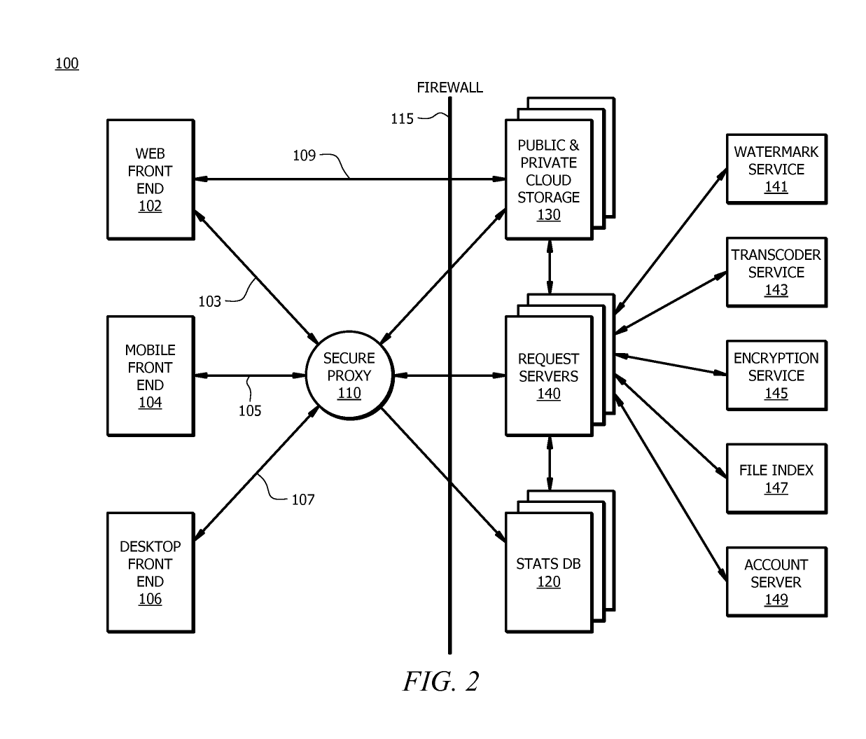

Now referring to FIG. 2, a system 100 is shown as a possible embodiment of the present teachings. A web 102, mobile 104, and desktop 106 front end connect to a secure proxy 110 that is outside of a firewall 115. Behind the firewall 115 are the request servers 120, public and private cloud storage 130, stats database 132, watermark service 141, transcoder service 143, encryption service 145, file index 147, and account server 149.

Front end pieces (web front end 102, mobile front end 104, and desktop front end 106) provide user interfaces to interact with system 100. Web front end 102 provides a web based portal for a user to login and listen to their music. Mobile front end 104 provides a mobile application for a user on a mobile device such as a smartphone or tablet. Desktop front end 106 provides a desktop application installed on a user's computer. Each front end piece 102, 104, 106 connects by an encrypted connection 103, 105, 107 to secure proxy 110. Encrypted connections 103, 105, 107 are SSL in a preferred embodiment (though other secure connections may be used) and can comprise wireless and/or wired connections. Web front end 102 can also comprise a direct connection 109 to public and private cloud storage 130. Front ends 102, 104, 106 will, in a preferred embodiment, require a user to login before use, such as with a password or pin. In a preferred embodiment, web front end comprises an application with an encrypted local cache that is able to access, store and play music files. Web front end 102 could be a local application or could be run via a browser.

Secure proxy 110 sits outside firewall 115 from back end servers 120, 130, 140. Secure proxy 110 also comprises direct connections to back end servers (stats database 120, public and private cloud storage 130, and request servers 140). Elements 110, 120, 130, 140, 141, 143, 145, 147, 149 can comprise physically distinct hardware or logically distinct portions of servers and/or other hardware and software.

Request servers 140 can receive requests for various services from front end devices 102, 104, 106 via secure proxy 110. Request servers 140 can then connect with watermark service 141, transcoder service 143, encryption service 145, file index 147 and account server 149. For example, a desktop front end 106 user may send a request to request servers 140 to watermark a new song. In a preferred embodiment, the request servers will then store an encrypted pristine version (un-watermarked) of the song file (such as a .wav file) in public or private cloud storage 130. Then the request servers 140 will use watermark service 141 to apply a sonic watermark to the file, then use transcoder service 143 to code the digital file to preferred format (such as .mp3), and then use encryption service 145 to encrypt the digital file for sending back to the user, or to other users that the song is being sent to. This process will be described in further detail below. Services 141, 143, 145, 147, and 149 can comprise physically distinct servers or computers, or can comprise logically distinct portions of a server(s) performing the functions of request servers 140.

Watermark service 141 applies a sonic watermark to digital files as requested by servers 140. As shown in FIG. 1, watermark service 141 will derive a first hash 10 that is user device specific. For example, a single user may use both a mobile front end 104 on a smartphone and a desktop front end 106 on a desktop. In this case the user's smartphone and desktop would have different first hashes 10. Watermark service 141 also derives a second hash 20 that will be instance unique. The preferred embodiment uses a first and second hash. The longer the string of characters for the input, the better. The inputs for the first and second hash can be different. Other embodiments can use any function that can produce a string of characters and still implement the present teachings. An “instance” is a single digital download of a song/file. As described in relation to FIG. 1, the first hash 10 will be used to determine a plurality of locations within a digital file. The second hash 20 (or portions thereof) will be embedded in the audio file at the locations determined by first hash 10. This “sonic watermark” will effect the audio file in a way that is imperceptible to the human ear, and can pass a phase inversion test (such that the summation will be equal to zero), but nevertheless leaves an audio impression on the file. As described further below, if a song is leaked/stolen, the system 100 can analyze the stolen audio file and compare it to all watermarked versions of the audio file and determine which user and which device the audio file was leaked/stolen from. Watermark service 141 will, in a preferred embodiment, apply the sonic watermark to a .wav (waveform audio file) or .aiff (audio interchange file format) file. Other types of files can be used.

After the watermark service 141, the transcoder service 143 can take the resulting watermarked file and transcode it into another audio format such as .mp3, .wav, .ogg, .aiff or another format. The chosen format can be chosen by the sender, recipient, or other system setting.

After transcoder service 143, the encryption service 145 can take the transcoded file and encrypt the file. The file can then be sent by the request servers 140 to the front end device 102, 104, or 106 of the user. Alternatively, for users on a web front end 102, the file can be placed on the public and private cloud storage 130 and the user can access it there directly from the web front end 102. Because the file is encrypted only the requesting user, or approved recipient, will be able to decrypt the file and listen to it by logging in to application 200.

File index 147 can perform several functions. In a preferred embodiment, file index 147 will store user data, encryption keys, and file information. For a given user, user data could include user name and password, user device identification data, number of devices or similar data. This can include encryption keys for the user's device(s). File index also provides file and object hierarchy.

Account server 149 can comprise permission and account data. As described in more detail below, users can share files through the disclosed system. A user sending a file to a recipient may wish to adjust various permission settings. Account server 149 can be arranged by song file or instance, where a song or instance can be looked up and the permissions for the song be reviewed. Alternatively, the system can arrange permissions by user: a user or user device can be looked up and the permissions and associated songs reviewed. A front end 102, 104, 106 secure proxy 110 and/or request servers 140 may wish to review account server 149 when a song is being shared or when a user is accessing new music to determine if the desired action is allowed for that particular song or user.

Public and private cloud storage 130 provides storage of various files. Pristine, pre-watermark versions of songs can be stored in encrypted form in cloud storage 130. The system will, in a preferred embodiment, use pristine versions to make necessary copies as the owner shares and sends the file to others. The stored version will preferably be a pristine version, as it is preferable not to apply a watermark to a previously watermarked version (to watermark a watermark). The pristine files can be used each time a request is made for a new “instance” of a song: the file will be copied, decrypted, watermarked, transcoded, encrypted, and sent to a recipient or user. Furthermore, watermarked songs can also be stored for when a user wants to access it from the public cloud storage. Public and private cloud storage 130 can comprise a plurality of servers and/or computers. The public and private sides may be physically separate or may be logically distinct portions of shared hardware such as servers.

Stats database 120 can track various data about song/file use, access, downloads, and more. For instance, for each song the following data will typically be tracked: request dates for the song, how song was accessed by each allowed user/recipient, number of plays, GPS location of device that accessed/downloaded the song, and other historical records related to a song's download and use history. This information will be used if the song is later stolen or leaked because the information can help track the source of the theft or leak, even if the leak is accidental.

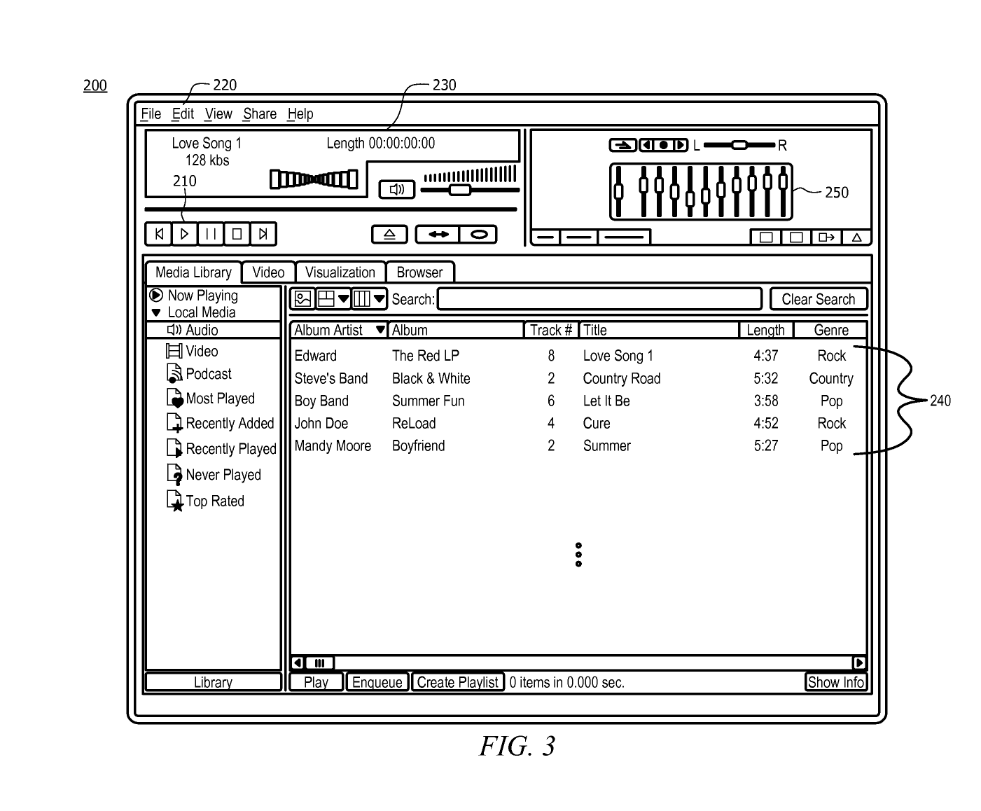

FIG. 3 displays an embodiment of a media player/application 200 according to the present disclosure. The system described, in the preferred embodiment, requires use of a special media player or application by each user of the system, so that songs/files can be appropriately watermarked, encrypted, and tracked. The files shared using the disclosed system cannot be played by any third party software or system. The media player 200 comprises playing buttons 210, file buttons 220, track information 230, track listing/catalog 240, and audio visualizer 250. Media player 200 can also comprise an audio mixer/editing tool for recording, mixing, cutting, sampling and otherwise editing audio tracks. A similar interface to player 200 can be adjusted for web, mobile and desktop front ends 102, 104, 106. Player 200 will have access to the location of the device (front end 102, 104, 106). This can be via a smartphone's GPS location services, cellular tower, a desktop's MAC address, IP address or another mechanism. Access to location services may require special permission from an app store or other interface. In a preferred embodiment, a user's refusal to allow access to location services will prohibit the user from downloading and using the system disclosed herein. In a preferred embodiment, a user will have to login or enter a password to access and use player/application 200. Media player/application 200, in the preferred embodiment, is a user's gateway to the use of the system disclosed in FIG. 2. Application 200 can be the means by which a user uploads music, shares music, sets permissions, receives music from other users, and otherwise interacts with system 100. Media player/application 200 can comprise the web, mobile or desktop front ends 102, 104, 106. File qualities, such as sample rate or other settings, can be set and adjusted from within application 200.

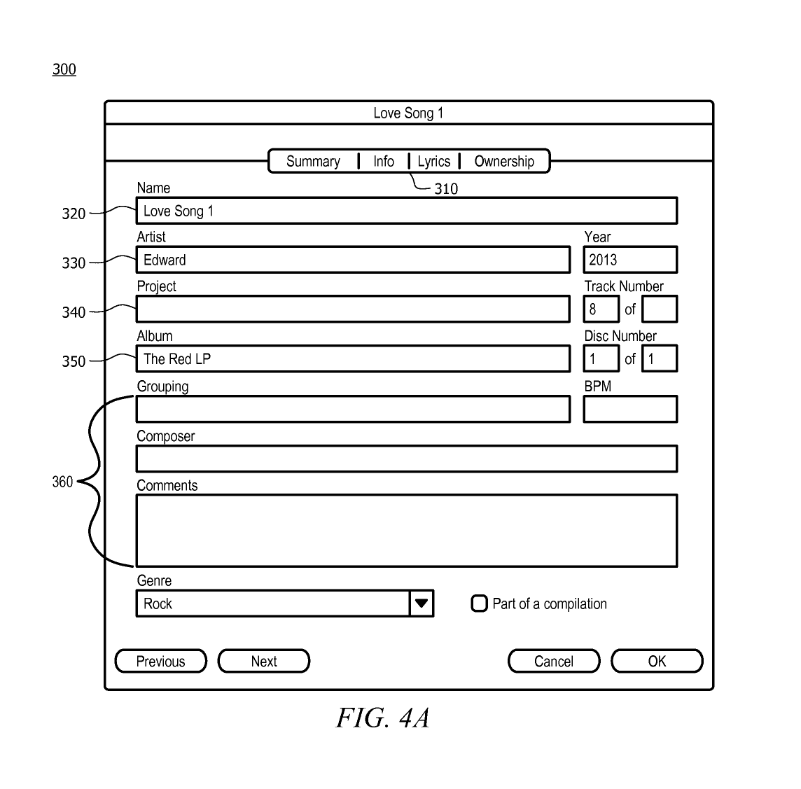

FIGS. 4A and 4B display an embodiment of file editing interfaces 300 according to the present disclosure. These user interfaces 300 can be used to edit metadata, permissions, and other song/file information. As shown in FIG. 4A, a song's title 320, artist 330, project 340, album 350, or other information 360 can be edited by a user. Buttons 310 allow the user to select among several menus for edits. FIG. 4B shows an interface for editing permission and ownership settings for a song. Song title is listed at 320 and permissions can be set for a plurality of other users 370. Permissions could be proxy ownership 380, or a plurality of other options. A user could choose to grant or revoke editing privileges, sharing privileges, or other settings. For instance, a user could send a song to a recipient, but via interface 300 could prohibit the recipient from sharing the song to further recipients. A user could also set a play count or time limit for a recipient. If a user makes a recipient a proxy owner, then the recipient could have full privileges for editing and sharing the song. A variety of options for permission and security settings could be included in interface 300. An owner of a song could also rescind or edit permission and ownership settings at any time. In some embodiments a song can have multiple owners, or multiple users with full privileges. The first uploader of the song would have to set the other users as owners or with full privileges. This might be useful when multiple members of a band want complete access to a song, when a band shares music with an agent or record label or another situation. Another option would be for sharing to be dependent on all owners of a song to agree/consent before the sharing can take place.

Referring again to FIG. 3, the media player/application 200 can be further described. In the preferred embodiment, any user who wishes to listen to music shared by another user will have to install or use the media player/application 200. Songs/files cannot be downloaded and listened to via another music application. A user's player 200, and the user's associated music library of watermarked songs, all comprise one file on a device. This is to provide extra security against a user hacking into a device and stealing individual files. A single song/file cannot be copied or dragged to another folder and stolen. If someone hacks into a user's device they would have to copy/drag the player/library composite file to another location. The file is encrypted by a hash and it will not be playable on the new device. The thief will not be able to distinguish code from distinct songs because the one composite file is encrypted. The player 200 can also provide for possible real-time watermarking from individual devices on playback. This would allow the system to protect against analog or room recording of files being played back in a semi-public forum.

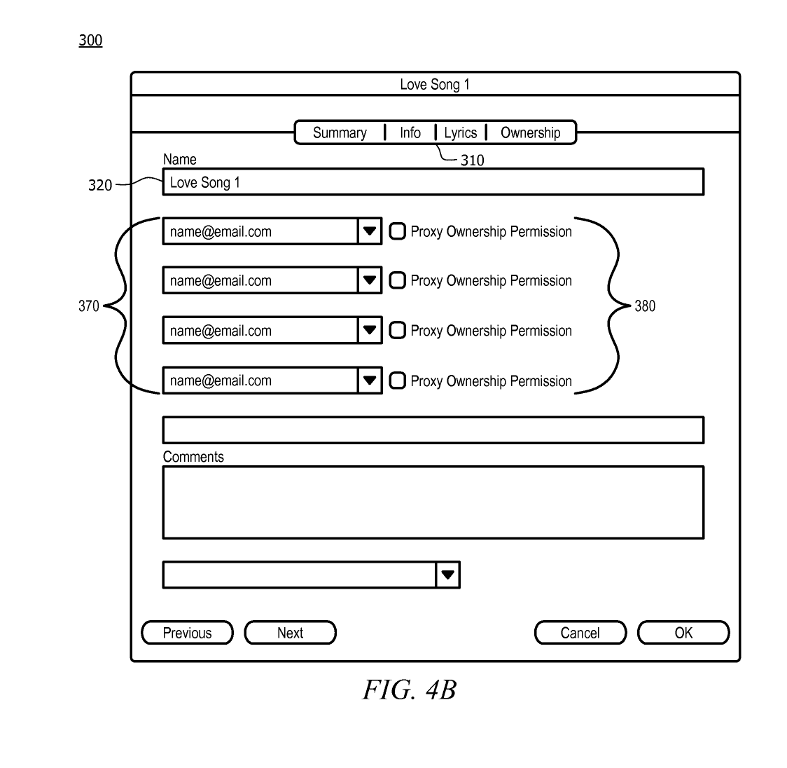

Referring to FIG. 5, an embodiment of a method of uploading a song 400, via application 200, can be seen. A command is received to upload a song 410. The command can occur by dragging a file (mp3, wav, etc) to the application 200, or using a file command, or any suitable mechanism. A copy is made of the file 420 and the copy is stored in a cache 430. The upload begins immediately if an internet connection is available 440. If no connection is available then the upload will begin later 450. A user's library can comprise uploaded files and other files that have not yet been uploaded. An indicator of some kind, such as colored or shaded text, may indicate which files have not been uploaded.

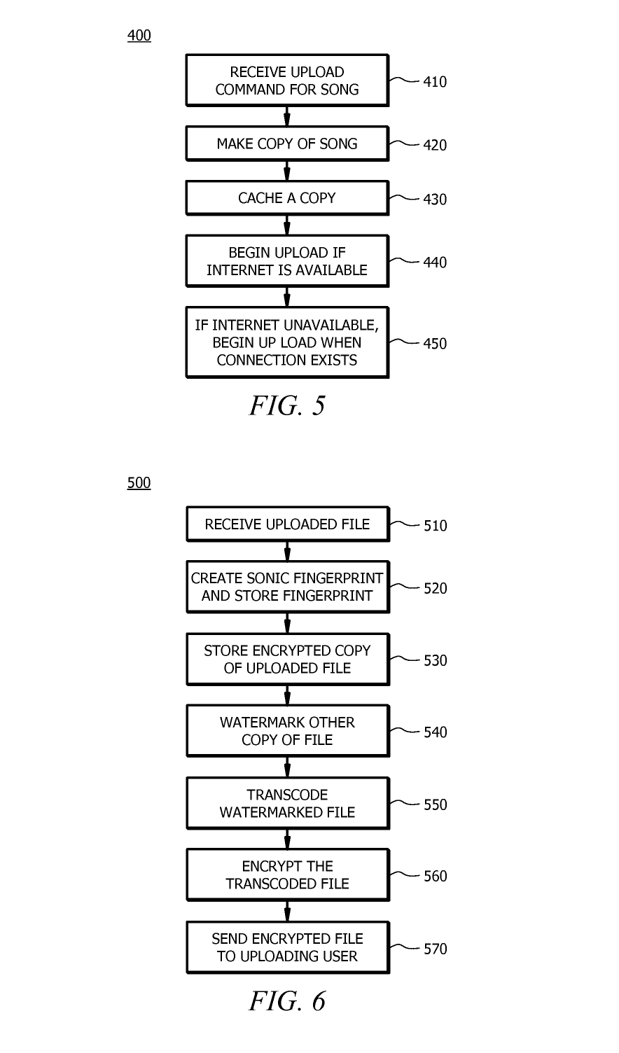

FIG. 6 shows an embodiment of the uploading process from the perspective of the servers behind the firewall 115 of FIG. 2. The uploaded file is received 510. A sonic fingerprint is created and stored 520. An encrypted copy of the uploaded file is stored on cloud storage 530. Another copy of the uploaded file is watermarked 540 (with the first and second hashes), transcoded 550, and encrypted 560 and then sent to the uploading user 570.

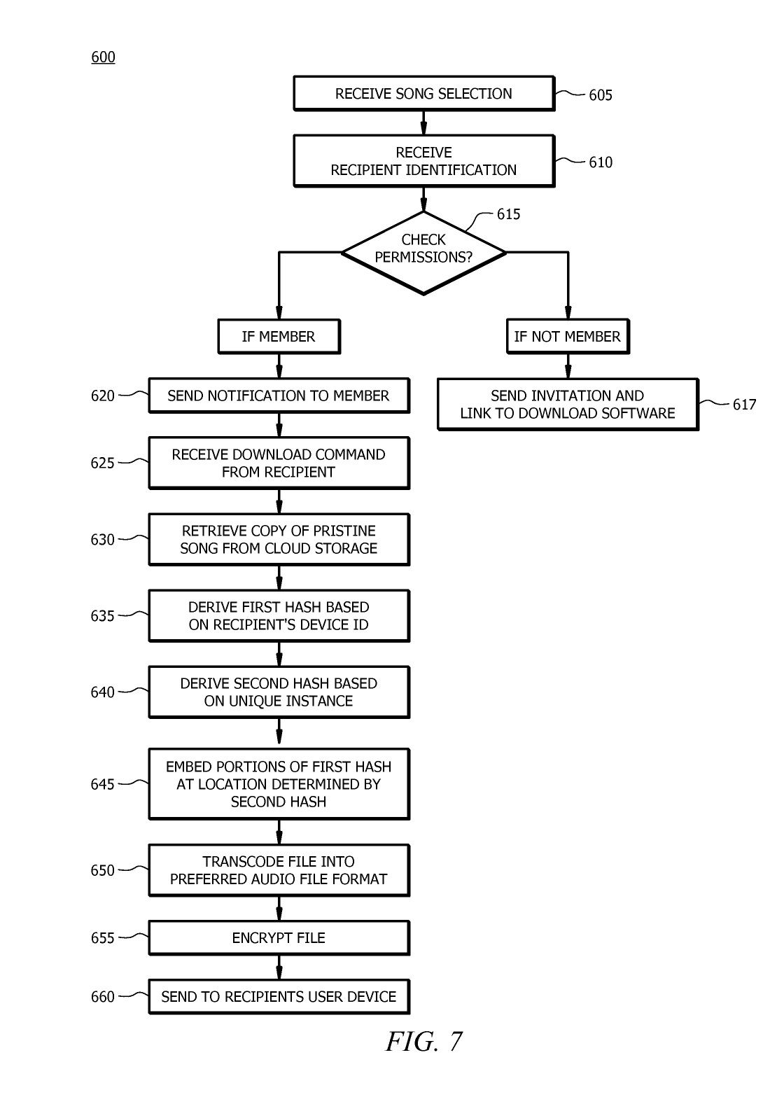

Embodiments of the sharing process and capabilities can now be described. FIG. 7 shows one such embodiment. A user can choose a song to share and name a recipient(s) 605 and 610. This is done by a file command, adjusting permission settings within the metadata, by a right-click and select, or other mechanism. In a preferred embodiment the request servers 140 (of FIG. 2) receive these selections. The permissions of the sender will be checked to ensure that he has permission to share the file 615. Permissions will, in the preferred embodiment, be stored locally at each device, but can be doubled checked at the account server 149 by request server 140. If the chosen recipient is not a member of the system, then an invitation is sent to him with a link to download and install the system software 617, such as application 200 for a front end 102, 104, 106. If the user does not download the software then he will not be able to download or listen to the song. Alternatively, if the intended recipient is a system member, then a notification is sent to him 620 via his application 200 at his user device. A command can then be received from the recipient at the request server to download the shared song 625. The request will carry the recipient device's identification. The pristine version of the song is then copied and decrypted from cloud storage 630. The copy is then used for the watermarking and coding process. The first hash is derived that is unique to the recipient's device 635. The second hash is derived and it is “instance” unique 640. At least portions of the second hash are embedded in the digital song file at locations determined by at least portions of the first hash, creating a sonic watermark 645. The file is then transcoded into a desired file format 650. The file is then encrypted 655 and sent to the recipient's device 660. If a user sends a song to multiple recipients then the preceding process must be carried out independently for each recipient, as the file received by each recipient will have a unique first and second hash and therefore a unique sonic watermark. If a recipient is allowed to download the song on multiple devices then the preceding process will repeat for each device, as the first and second hashes will be unique for each device and the sonic watermark will therefore be unique for each device. If a recipient has permission to re-share a song, then the copies sent to secondary recipients will result from the same process laid out above, each recipient receiving a unique instance of the song. When a song is downloaded by a recipient, the file is embedded/appended to the single file that comprises player/application 200 and the user's music library. A user may have separate mp3 or other music files apart from the disclosed system. But the watermarked music files and the player application 200 will, as described above, comprise a single encrypted file.

When a file is uploaded it is sonically fingerprinted and the sonic fingerprint is stored in cloud storage. An acoustic fingerprint is a digital summary of a recording. In a preferred embodiment, fingerprinting will involve hashing the content of a song or portion of a song, though other fingerprinting methods may be used, as is well known in the art. Every song uploaded is compared to other sonic fingerprints stored. This serves as protection of copyright and a warning if one artist is stealing from another. Alternatively, two users might unknowingly upload similar songs and each will be notified. This may prevent future litigation. The sonic fingerprint may also assist in alerting band members, for example, that they are uploading the same songs and duplicating efforts. They may want to stop, or may want to ensure to set the same permissions on the duplicate songs, or delete one.

As a song is shared and sent to other users the stats database 120 from FIG. 2, discussed above, can track various data. Each front end 102, 104, 106 comprising an application 200 will in real-time or at set intervals send tracked data to the stats database 120 via secure proxy 110. Tracked data can include all sharing paths, number of plays, what part of a song gets played or repeated, the location during each play, device ID, instance ID, and other desired information.

If a song is leaked or stolen and shows up among the general public, or with an unauthorized individual then the system disclosed can determine the source of the theft or leak. The most likely source of theft would be someone taking an audio recording as a song is played on a user device through a front end 102, 104, 106 as in FIG. 2. However an unauthorized copy is obtained, the unauthorized copy can be sent to request server 140. Request server 140 will take an audio fingerprint and find similar songs stored in cloud storage 130. It will then look for the watermark in the unauthorized copy, comparing it to the various watermarked versions that have already been created for the particular song. Once a user device has been identified, the request server 140 can query the stats database 120 to determine how many times the song was played on the identified device, at what time and at what locations. Thus the source of the leak/theft can be identified. The users may then be able to narrow down the time frame and location of the leak.

When a music album/single/track is ready for distribution to the public, request server 140 can assemble the appropriate tracks requested by the owner(s) and send them in un-watermarked form to the record label or other preferred recipient. Once the songs are distributed to the public via CD, sold on mp3, or other means, the teachings disclosed will generally no longer be effective for preventing leaks. Not every consumer uses application 200 and the front end devices 102, 104, 106 disclosed herein, and consumers will likely want to listen to their music however they choose. As such, it will not be necessary to distribute watermarked files to consumers. However, if the teachings disclosed did become widely used among consumers, the systems and methods described could be used for the sale and distribution of music to consumers. The system would be adaptable to comprise a payment platform, and would provide the benefit of increased security and less music piracy.

The teachings disclosed herein have been described in regards to audio files. However, the teachings can be used and applied to other types of files as well, such as video. A first and second hash, as described above, can be used to embed a watermark in the audio track of a video file, or even to adjust the video image as a video watermark.

One possible embodiment can use the following code for the watermarking, detection, and extraction functions of the present teachings.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of watermarking an audio file comprising:
receiving, at a server, a digital audio file;
receiving, at a server, a request for the digital audio file, the request comprising a user device identification and a file format request;
deriving, at a server, a first hash, the first hash comprising a unique user device identification value;
deriving, at a server, a second hash, the second hash comprising an instance unique identification value;
embedding, at a server, at least a portion of the second hash at locations within the digital audio file determined by the first hash to create a watermarked file;
transcoding, at a server, the watermarked file into the file format requested;
encrypting, at a server, the watermarked and transcoded file; and
sending, by a server, the encrypted file to the user device.

2. The method of claim 1 further comprising storing, at a server, an encrypted copy of the digital audio file.

3. The method of claim 1 further comprising creating, at a server, an audio fingerprint of the digital audio file.

4. The method of claim 3 further comprising comparing, at a server, the audio fingerprint to a plurality of other audio fingerprints.

5. The method of claim 1 wherein the transcoding comprises creating an mp3 file.

6. The method of claim 1 wherein the received digital audio file is an aiff file.

7. The method of claim 1 wherein the transcoding comprises creating an ogg file.

8. The method of claim 1 wherein the received digital audio file is a wav file.

9. A method of creating and sharing audio files comprising:
receiving, at a server, a digital audio file from a first user;
receiving, at a server, permission settings for the digital audio file from the first user;
receiving, at a server, a request for the digital audio file from a second user, the request comprising a user device identification;
determining, at a server, that the permission settings allow the second user to download the digital audio file;
deriving, at a server, a first hash, the first hash comprising a unique user device identification value;
deriving, at a server, a second hash, the second hash comprising an instance unique identification value;
embedding, at a server, at least a portion of the second hash at locations within the digital audio file determined by the first hash to create a watermarked file;
transcoding, at a server, the watermarked file into the file format requested;
encrypting, at a server, the watermarked and transcoded file; and
sending, by a server, the encrypted file to the user device of the second user.

10. The method of claim 9 further comprising storing, at a server, an encrypted copy of the digital audio file.

11. The method of claim 9 further comprising creating, at a server, an audio fingerprint of the digital audio file.

12. The method of claim 11 further comprising comparing, at a server, the audio fingerprint to a plurality of other audio fingerprints.

13. The method of claim 9 wherein the transcoding comprises creating an mp3 file.

14. The method of claim 9 wherein the transcoding comprises creating an aiff file.

15. The method of claim 9 wherein the transcoding comprises creating an ogg file.

16. The method of claim 9 wherein the digital audio file is received as a wav file.

17. A system for watermarking, encrypting, and storing audio files comprising:
a secure proxy located outside a firewall and operable to communicate with a plurality of front end devices;
a cloud storage located inside the firewall and in communication with the secure proxy, and operable to store audio files;
a statistics database located inside the firewall and in communication with the secure proxy, and operable to receive location and play data regarding audio files from the plurality of front end devices;
a request server located inside the firewall and in communication with the secure proxy, the cloud storage and the statistics database, and operable to receive audio files from the plurality of front end devices, further operable to receive a download request for an audio file from a requesting front end device;
a watermark server located inside the firewall and in communication with the request server, and operable to receive a requested audio file from the request server and embed a first and second hash within the requested audio file, wherein the first hash is unique to a front end device and the second hash is instance unique, and wherein at least a portion of the second hash is embedded in the requested audio file in at least one location determined by at least a portion of the first hash;
a transcoder located inside the firewall and in communication with the request server, and operable to receive the watermarked audio file from the request server and to transcode the watermarked audio file into a desired audio format;
an encryption server located inside the firewall and in communication with the request server, and operable to received the transcoded audio file from the request server and to encrypt the transcoded audio file;
a file index located inside the firewall and in communication with the request server and operable to store encryption keys; and
an account server located inside the firewall and in communication with the request server and operable to store permission settings related to an audio file;
wherein, when the request server receives a download request from a requesting user the request server confirms the requesting user's permissions with the account server, the request server then operable to copy the requested audio file from the cloud storage and send it to the watermark server to be watermarked, then to the transcoder to be transcoded, and then to the encryption server to be encrypted, and the request server operable to send the encrypted, transcoded and watermarked audio file to the requesting user.

18. The system of claim 17 wherein the request server is further operable to create an audio fingerprint of an audio file.

19. The system of claim 17 wherein the plurality of front end devices comprises a mobile device.

20. The system of claim 17 wherein the secure proxy is operable to communicate with the plurality of front end devices over SSL.
